(19) United States
(12) Patent Application Publication
(10) Pub. No.: US 2003/0176995 A1
(43) Pub. Date: Sep. 18, 2003

(54) Translation mediate system, translation mediate server and translation mediate method

(75) Inventor: Tatsuya Sukehiro, Osaka (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/385,468

(22) Filed: Mar. 12, 2003

(30) Foreign Application Priority Data
Mar. 14, 2002 (JP) JP2002-070379

(51) Int. Cl. G06F 17/28

(52) U.S. Cl. 704/2

(57) ABSTRACT

The dictionaries which each of translators made are registered in translator dictionary database (11) of translation mediate server (4) being divided into each special field where corresponding translators belong. And, the client requesting for translation sends document to be translated, from for example, client terminal (1A) to translation mediate server (4). There, automatic translating means (10) reads out translation dictionary corresponding to this document field of translator dictionary database (11). And, it performs automatic translation of the document by using this dictionary. This translation result is sent to client terminal (1A), for the client requesting for translation to select the best translator. The selected translator is informed of translation request at his or her terminal, for example, translator terminal (2A).

### BACKGROUND OF THE INVENTION

1. Field of the Invention

The present invention relates to a translation mediate system, a translation mediate server and a translation mediate method to provide an adequate mediation between the client requesting for translation and the translator in network, which is performed by making use of automatic translating means.

2. Description of Prior Art

In conventional art, there is a translation mediate system, which mediates between client requesting for translation and translator, operated on Web. This kind of system provides us with service of ordering translation by on-line system.

That is, in this translation mediate system, the client requesting for translation is able to directly refer to information about translators on Web. And, charge for translation is calculated from the number of words or characters in the original of document times unit charge, so as to present it to the client. By adopting these methods, translation may be ordered easily and adequately.

Moreover, in this system, the client requesting for translation can evaluate the ability of the translator. And, the result of the evaluation is accumulated, so as to give ranks to translators. With this ranking, the client requesting for translation can spontaneously select the best translator by considering translation skill, as well as charge, offering date of translated document and so on. And, translations are ordered adequately.

Moreover, in this system, field of translation is divided into several fields which concern to such affairs as IT, business, contract documents, or documents dealing with special fields such as law, mechanical engineering, science, medicine etc. And, translators can volunteer for their favorite fields.

Besides, the translators not skilled in each field could not be given normal charge for a while. They could take enough charge only after they get skilled. That is, they can get enough income after they have obtained translation experience in those fields. By adopting this arrangement, clients requesting for translation are protected from receiving translated documents with low quality.

However, in the conventional art mentioned above, the translators' favorite fields are volunteered on their own ideas. So, it is not certain whether they are really skilled in those fields or not. And, each field was wide enough to include both of skilled affairs and not skilled affairs for the translators. But, clients requesting for translation were not aware of these facts. And, they could not exactly evaluate translators. As a result, there was a problem that it was difficult for them to select the best translator whom they really want.

On the other hand, the translators who were not recognized to have enough translation careers, were obliged to translate without enough charge for a certain period of time while they were checked about their translation skill, according to the conventional art. This is painful for the translators who already have enough skill for translation in their favorite fields. So, these translators were not willing to register themselves in this system. As a result, good translators were not assembled in system.

Besides, there is a case when clients requesting for translation appoint words to be translated. For example, there is a case when they wish the words or phrases about their products and so on, to be translated into specific words. In this kind of case, the clients requesting for translation handed the translator a list of words corresponding for translation. Here, if different translators were selected at different opportunities of the same case, they had to hand each of translators the same list. So, there was a problem of bothering the clients with trifles.

On the other hand, the translator handed with many translation lists, was bothered with referring to the list at translating original document. And, some of the translators are likely to overlook some words on the list. So, inappropriately translated documents were often offered to the client.

### SUMMARY OF THE INVENTION

Therefore, the presenting invention is aimed at providing a translation mediate system which is able to perform the optimum mediation between translator and client requesting for translation, by utilizing automatic translating means.

Moreover, the clients requesting for translation are able to select translators skilled in the field of document to be translated, judging from automatic translation result for themselves, to request for translation. And, translators are able to appoint their favorite fields in detail, to accept the request for translation of the field. These are the objects of the translation mediate system of present invention.

Therefore, the present invention has next features.

First, to realize a system for performing optimum mediation between the translator and the client requesting for translation, a translation mediate server is provided to comprise the system. The translators register their technical term dictionary of their favorite field in this translation mediate server. And, the clients requesting for translation select translators by using the dictionaries which the translators made. In this occasion, the client requesting for translation can be assisted by automatic translation. That is, the translation mediate server comprises an automatic translating means for translating a sample document with the translators' dictionaries. And, the client contrasts each translation result with other translation result. So, the client can make translation request to the translator with the best translation quality.

Therefore, the system comprises client terminals, translator terminals, the translation mediate server and network to connect these terminals to the translation mediate server. And, in the server in the system, at least the translators' dictionaries which the translators themselves made via translator terminals are registered dividing into each special field. On the other hand, the client requesting for translation sends document to be translated from client terminal to the translation mediate server. This document is translated by using translators' dictionaries corresponding to the field of document. And, the translation result is sent to the client terminal. There, the client requesting for translation selects a translator, to inform the selected translator's terminal of translation request via translation mediate server.

### BRIEF DESCRIPTION OF THE DRAWINGS

FIG. 1 is a block diagram showing a configuration of First Embodiment.

FIG. 2 is a flowchart showing the processes of selecting a translator.

FIG. 3 is a flowchart showing the processes of presenting a translation result.

FIG. 4 is a flowchart showing the processes of registering a dictionary by a translator.

FIG. 5 shows an example of dictionary registering screen.

FIG. 6 is a block diagram showing a configuration of Second Embodiment.

FIG. 7 is a flowchart showing the process of registering a dictionary by a client requesting for translation.

FIG. 8 is a flowchart showing the processes of presenting a translation result.

FIG. 9 is a block diagram showing a configuration of Third Embodiment.

FIG. 10 shows an example of translation result screen for correcting.

FIG. 11 is a flowchart showing the processes of correcting the translation result.

FIG. 12 is a block diagram showing a configuration of Fourth Embodiment.

FIG. 13 is a flowchart showing the processes of automatic selection of the translator.

FIG. 14 is a block diagram showing a configuration of Fifth Embodiment.

FIG. 15 is a flowchart showing the processes of merging dictionaries by the translator.

### DESCRIPTION OF THE PREFERRED EMBODIMENTS

Hereafter, referring to the figures, several embodiments of translation mediate system according to present invention will be described. <First Embodiment>

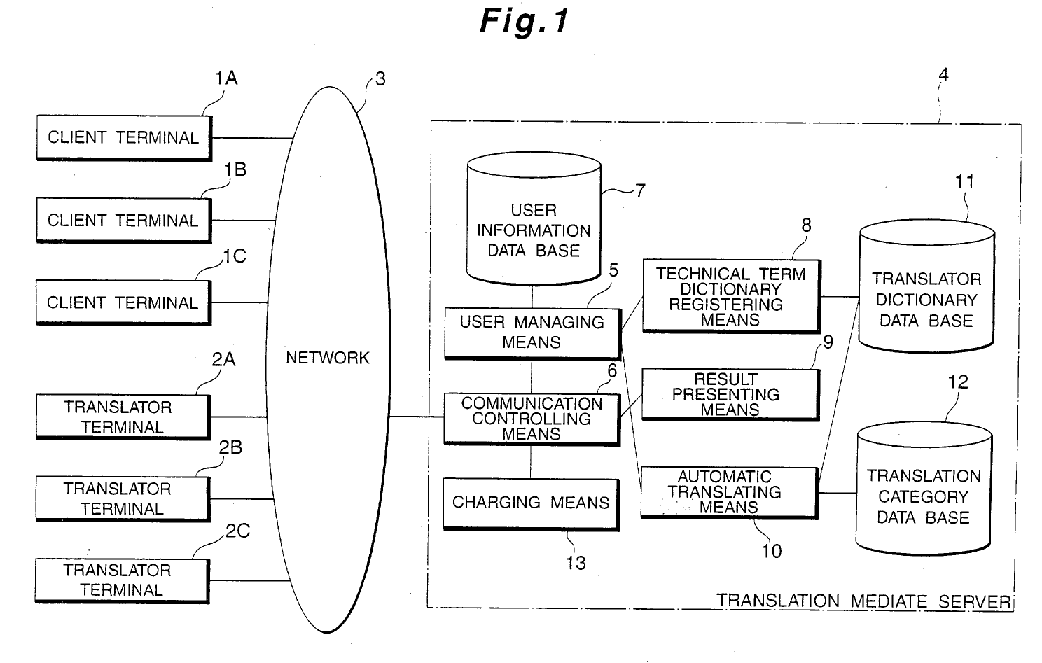

First of all, a configuration of First Embodiment is described, referring to the block diagram shown in FIG. 1.

In FIG. 1, client terminals 1A to 1C and translator terminals 2A to 2C are connected via network 3 to translation mediate server 4, so as to construct a system where mutual communication is processed. There, the client terminal 1A to 1C are operated by clients requesting for translation. The translator terminals 2A to 2C are operated by translators. The network 3 is a communication network such as Internet. And, the translation mediate server 4 realizes the present invention with the client terminals 1A to 1C and translator terminals 2A to 2C via network 3.

Although, client terminals 1A to 1C and translator terminals 2A to 2C are equipped each three as shown in FIG. 1, each of these terminals are not limited to this number.

The client terminals 1A to 1C are equipped with functions such as for getting access to the translation mediate server 4, viewing data of other servers, and receiving the translation result from the translation mediate server 4.

And, the translator terminal 2A to 2C are equipped with functions such as for getting access to the translation mediate server 4, viewing data of other servers, receiving document to be translated, and sending the translation result to the translation mediate server 4.

On the other hand, the translation mediate server 4 is a server for performing mediation between a translator and a client requesting for translation looking for translators. And, it comprises a user managing means 5, a communication controlling means 6, a user information database 7, a technical term dictionary registering means 8, a result presenting means 9, an automatic translating means 10, a translator dictionary database 11, a category database 12, a charging means 13 etc.

Here, the user managing means 5 has functions for registering the client requesting for translation and the translator, performing management of logging in to the site of translation mediate server 4 by the client requesting for translation and the translator, and some other functions.

The communication controlling means 6 controls communication with the client terminal 1A to 1C or translator terminal 2A to 2C via network 3.

The user information database 7 is a database for preserving information concerning the translator or client requesting for translation. It memorizes, for example; each translator's special field or translation history; user name, password, identification code of each translator or client requesting for translation; and charge remittance account of each translator etc.

The technical term dictionary registering means 8 provides interface for the translator to register dictionary data for automatic translation. It has a function for writing to register dictionary data offered by the translator in the translator dictionary database 11.

The result presenting means 9 presents the translation results obtained by using each dictionary which each translator made. These results are presented at client terminal 1A to 1C with contrast. And, the client requesting for translation selects the best translator presenting the best result.

The automatic translating means 10 translates the given document into other language by using each dictionary of translators. This automatic translating means 10 can be made of the conventional machine translation device.

The translator dictionary database 11 is what registers technical terms and so on in each personal dictionary of each translator. These terms are registered in each special field where the corresponding translated terms are registered. And, these translated terms are what the translator thinks the most suitable to the corresponding field. An identification code peculiar to the translator is attached to each dictionary. And, user managing means 5 searches for translators with this identification code in user information database 7. Thus, each dictionary of the translator can be read out.

The translation category database 12 is a database for memorizing genre where the special field for translation is classified etc.

The charging means 13 is what is for managing flow of money from the client requesting for translation to the translator, so as to make payment for translation without fail.

Next, the operation of the system is described. Hereafter, in the description, the operation of network 3 via which mutual communication between client terminal 1, translator terminal 2 and translation mediate server 4 is processed is omitted not to be described because it is known well and it is not a point of present invention. Similarly, the description of operation of communication controlling means 6 in translation mediate server 4 is omitted.

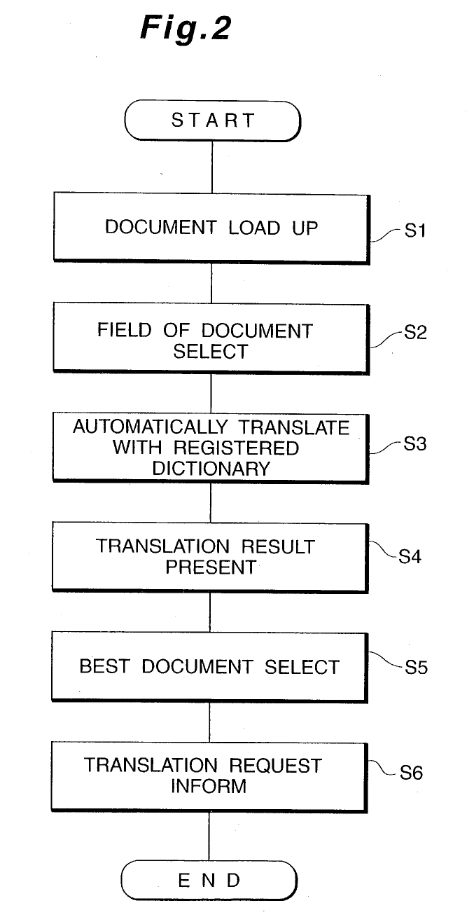

FIG. 2 is a flowchart showing the process of selecting the translator by the client requesting for translation. According to the steps shown in this FIG. 2, how to select a translator when translation is requested is described.

S1: At first, the client requesting for translation operates, for example, client terminal 1A to connect with translation mediate server 4. And, on the initial screen provided from translation mediate server 4, “translation request” is selected by the operator at client terminal 1A. Then, document to be translated is loaded up from this client terminal 1A to translation mediate server 4.

Here, what is processed is trial translation by automatic translation. So, it is not necessary to load up whole document at this moment. A part of document will do for the process.

The document loaded up is memorized in memory not shown in the drawings equipped in translation mediate server 4.

S2: The client requesting for translation selects the field of document to be translated, on the screen presented at display of client terminal 1.

S3: After being selected a field, user managing means 5 searches the user information database 7 for the translators corresponding to that selected field. As a result of this searching process, automatic translating means 10 gets a list of translators. And, according to this list, each dictionary corresponding to each translator is obtained from translator dictionary database 11, so as to perform translation by using this dictionary.

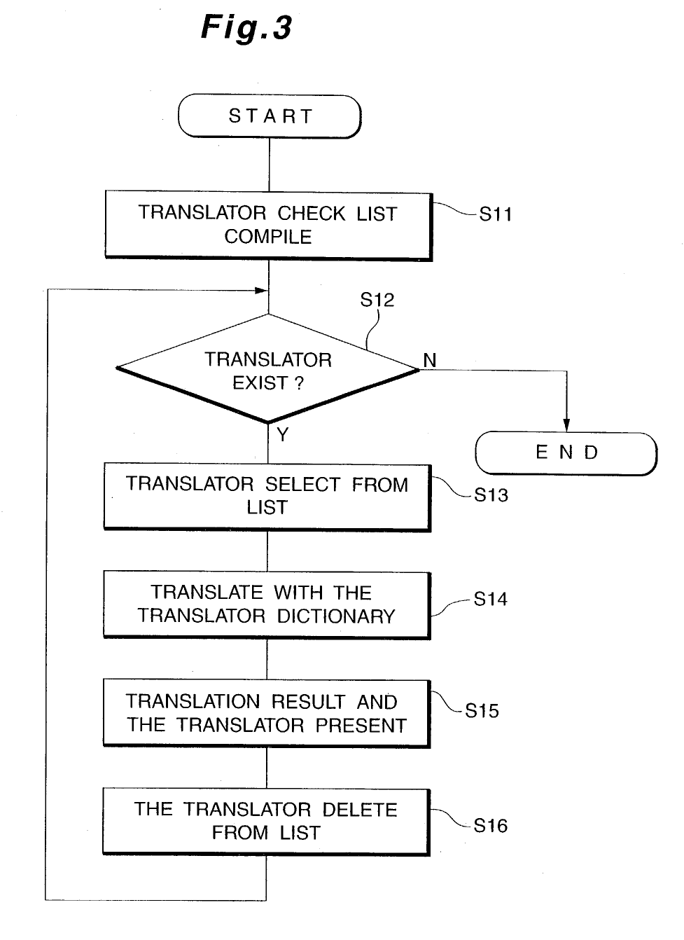

Thus, in the translator dictionary database 11, each translator's dictionary is registered in advance. And, automatic translating means 10 performs translation by using each dictionary for all the translators registered in the field selected by client requesting for translation. This process is described in detail later referring to FIG. 3. Moreover, dictionary registering is also described later.

S4: The result presenting means 9 sends the results of automatic translation performed by automatic translating means 10 to the client terminal 1A one after another. And, the display of client terminal 1A presents them on the screen.

S5: When all the translation results are sent to client terminal 1A, the client requesting for translation contrasts all the presented translation results with each other. And, the client selects the translation with best quality at client terminal 1A. After this, the result of selection is sent to translation mediate server 4.

S6: The translation mediate server 4 searches for the translator corresponding to the selected translation result. And, it informs the translator of translation request.

For example, when the translator corresponding to the selected translation result is an operator at translator terminal 2A, it informs the translator terminal 2A of the translation request.

FIG. 3 is a flowchart showing the process of presenting automatic translation result. This process corresponds to the steps S3 and S4 in FIG. 2.

Hereafter, this presenting process is described according to the steps designated by “S” shown in FIG. 3.

S11: The user managing means 5 searches the user information database 7 for the translator in the field selected by client requesting for translation. And, it makes the translators' checklist corresponding to the field.

S12: The user managing means 5 judges whether any translator exists in the checklist. And, if any translator does not exist, the process ends.

S13: The user managing means 5 selects a translator from the checklist. And, it informs the automatic translating means 10 of the translator's identification code.

S14: The automatic translating means 10 reads out the dictionary registered in translator dictionary database 11 according to the translator's identification code. And, it performs automatic translation by using the dictionary as well as ordinary system dictionary.

S15: The result presenting means 9 presents user name of the translator who used the dictionary, translation result etc. on the display of client's terminal, for example, client terminal 1A.

S16: The user managing means 5 deletes the translator from the checklist. And, the process returns to S12, so as to repeat same steps S12 to S16 until all the translators in the checklist are deleted.

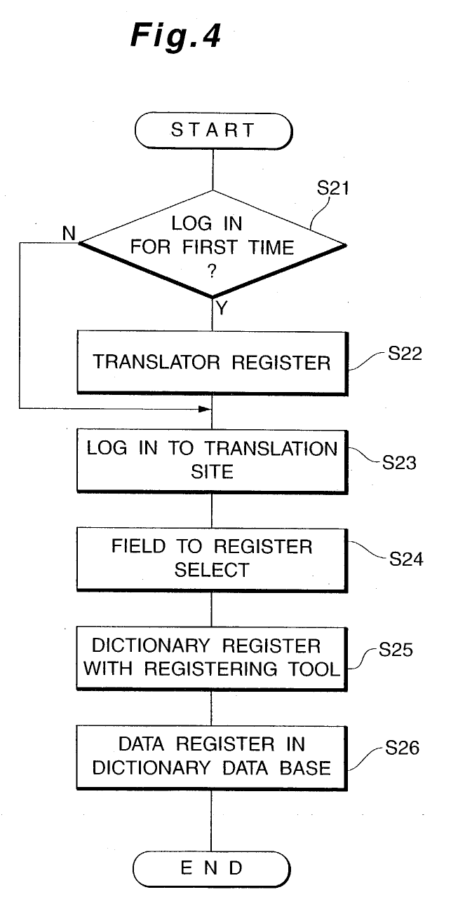

FIG. 4 is a flowchart showing the process of registering dictionary by the translator. According to the steps designated by “S” shown in this FIG. 4, the registering process is described.

S21: The translator operates, for example, translator terminal 2A to connect with translation mediate server 4. And, when the translator selects the dictionary registering on the initial screen provided from translation mediate server 4, the user managing means 5 receives the registering indication and checks whether it is the first dictionary registering or not.

As for a method of this check, for example, the following is adopted. The translator is let to input the special field. And, the translator is presented with a dictionary look-up table containing all the dictionaries registered in that field. Then, the translator is inquired whether there is his or her dictionary in that table or not. This is generally done and not so special method.

As a result of this checking, if dictionary is going to be registered for the first time, the process proceeds to next step S22, otherwise, the process proceeds to S23.

S22: The translator registers himself or herself as a user of the system.

That is, as the translator operates translator terminal 2A to input user name and password, they are sent to the translation mediate server 4 and memorized in the user information database 7 by user managing means 5. Thus, the user name and password are registered.

S23: The translator's log in to translation site is performed. At this step, user managing means 5 indicates the translator to input the translator's user name and password etc. by translator terminal 2A.

S24: The user managing means 5 indicates the registered translator to register dictionary. The translator selects field of dictionary registering according to this indication with translator terminal 2A.

S25: The translator performs dictionary registering on dictionary registering screen presented at display of translator terminal 2A controlled by technical term dictionary registering means 8.

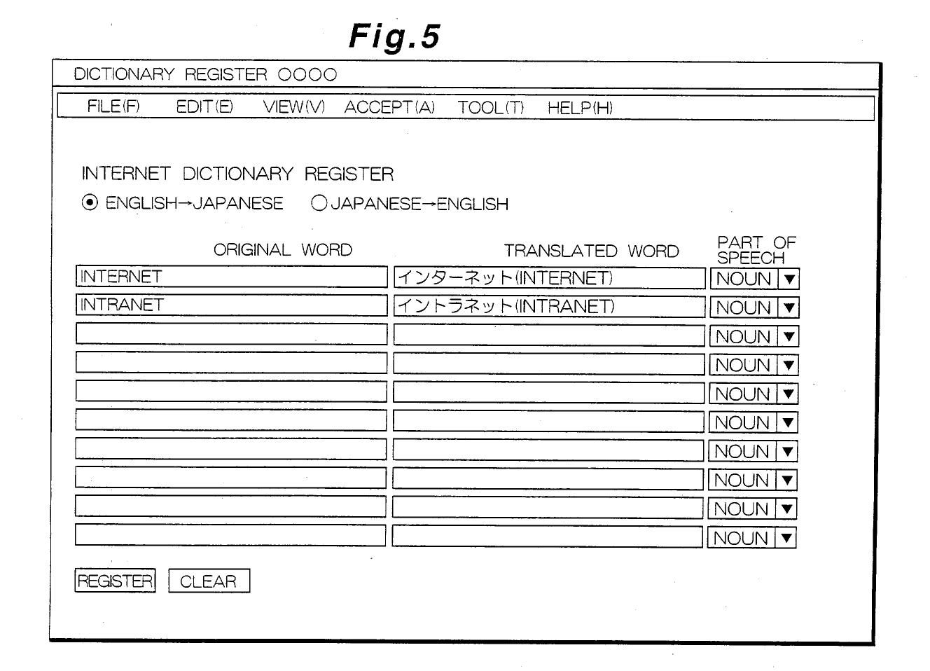

FIG. 5 shows an example of dictionary registering screen presented by above process. For example, English-Japanese dictionary is registered. Here, the screen is made up to write in the original word, the translated word and part of speech.

S26: After writing in them, the translator clicks the button of “register” in the screen. Then, by technical term dictionary registering means 8 the data of original word, translated word and part of speech etc. are registered in dictionary area of the corresponding field of translator dictionary database 11 as well as identification code etc.

Here, in the occasion of the translator's dictionary already registered, the present registered dictionary is added to the dictionary already registered.

As it is described above, in First Embodiment, clients requesting for translation are able to select the translator of most adequate level in the field of document to be translated, in judgment from automatic translation result. Thus, by requesting translation of document to such selected translator, even for expert document, expected is an effect that highly sophisticated translated document is obtained.

Moreover, the translator's dictionary is registered in translation mediate server, to use for trial automatic translation. Therefore, translators are given with equal opportunity of translation request. And, expected is another effect that highly skilled translators are easily assembled, availing of this opportunity.

<Second Embodiment>

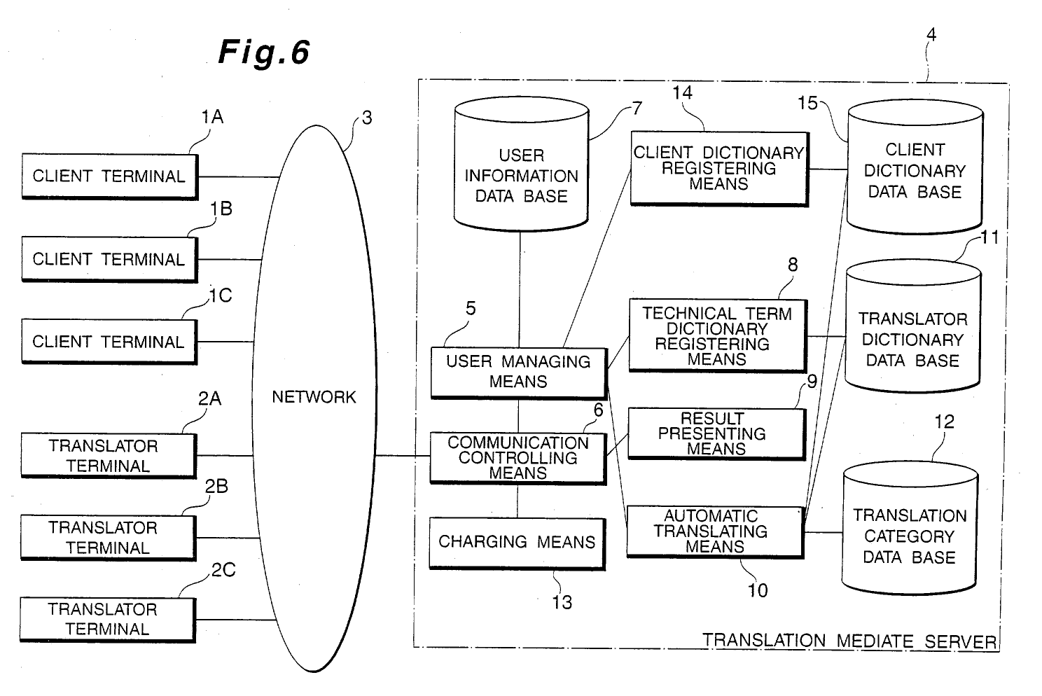

FIG. 6 is a block diagram showing a configuration of Second Embodiment.

The configuration of this embodiment is made by adding to the configuration of First Embodiment; a client dictionary registering means 14 and a client dictionary database 15. Both of these are equipped to the translation mediate server 4, so as to register the clients' own dictionary data.

Here, the client dictionary registering means 14 provides an interface for clients requesting for translation to write their dictionary data in the client dictionary database 15. And, the client dictionary database 15 is a database for preserving dictionary data which the client requesting for translation registered.

In addition, the other configuration elements are designated with the same symbols as in First Embodiment (FIG. 1). And, the description is omitted.

Moreover, in Second Embodiment, to request translation, how to select the translator is same as described in FIG. 2 of First Embodiment. So, the description is omitted. And, how the translator registers dictionary is same as the process described in FIG. 4 of First Embodiment. So, the description is omitted.

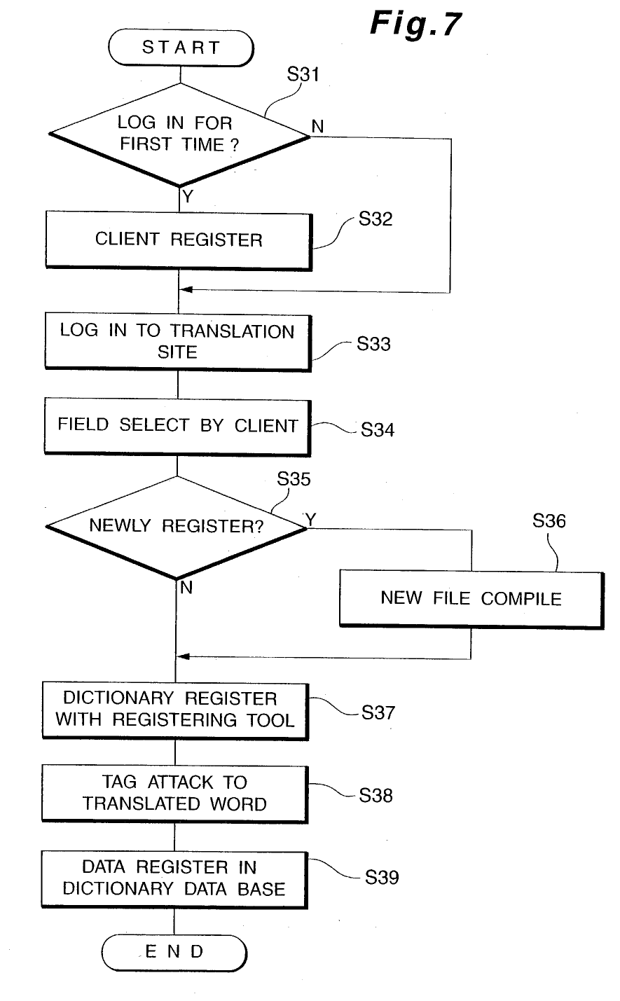

FIG. 7 is a flowchart showing how the client requesting for translation registers dictionary. The process is described according to the steps designated with “S” shown in this FIG. 7.

S31: The client requesting for translation operates, for example, client terminal 1A, to inform translation mediate server 4 of information to offer dictionary registering. Then, user managing means 5 inquires of client terminal 1A whether this is the first log-in. And, it checks whether this is the first log-in or not. If not, the process proceeds to S33.

S31: Moreover, the client requesting for translation operates, for example, client terminal 1A, to connect with translation mediate server 4, so as to be provided with initial screen from translation mediate server 4. Then, the client selects dictionary registering. And, at receiving this, user managing means 5 checks whether this is the first dictionary registering or not.

As a method of this checking, a general method such as presenting the client requesting for translation with a list of dictionary registered for the client requesting for translation, to inquire whether there is any dictionary of the client requesting for translation in the list etc.

As a result of check, if this is the first time, the process proceeds to next step S32. Otherwise, it proceeds to S33.

S32: The client requesting for translation performs user registering.

That is, the client requesting for translation operates client terminal 1A to input user name and password. Then, user managing means 5 memorizes the user name and password in user information database 7. Thus, the registering is performed.

S33: According to indication of user managing means 5, the client requesting for translation inputs his or her user name and password etc. with translator terminal 2A, to log in to translation site.

S34: According to indication of user managing means 5, the client requesting for translation selects the field of dictionary to register with client terminal 1A.

S35: The user managing means 5 searches client dictionary database 15 for the dictionaries registered corresponding to the field inputted by the client requesting for translation. And, it reads out them to compile a list with them. This list of the registered dictionaries is presented at display of client terminal 1A. And, it is checked whether there is a dictionary the client requesting for translation appointed in this list or not. By this check, whether this registering is new registering or not is checked. If this is new registering then the process proceeds to S36. Otherwise, it proceeds to S37.

S36: The user managing means 5 makes a new file for client's dictionary.

S37: The client requesting for translation performs dictionary registering on dictionary registering screen (dictionary registering tool) presented at display of translator terminal 2A by client dictionary registering means 14.

In this occasion, the screen for registering dictionary is same as that of FIG. 5. For example, as for English-Japanese dictionary, the screen is made up to write in original word, the translated word and part of speech.

S38: After finishing writing in, the client requesting for translation clicks “register” button on the screen. Then, tags are attached to the translated word data by client dictionary registering means 14.

For example, as for the translated word “ [symbol] ” which means “internet”, tags are attached to it as follows.

<user id=1204> [symbol] </user>

These are attached for discriminating the translated word appointed by the client requesting for translation in this dictionary from other translated words, not to be corrected when the document translated with the client's dictionary is checked later.

S39: After finishing attaching tags; the data of original word, translated word and part of speech etc. are registered in an area of corresponding field in client dictionary database 15 by client dictionary registering means 14, as client's dictionary.

When the client's dictionary is already registered, the dictionary of this time is added to the registered dictionary.

In addition, the same client requesting for translation is able to register dictionaries in plural fields respectively.

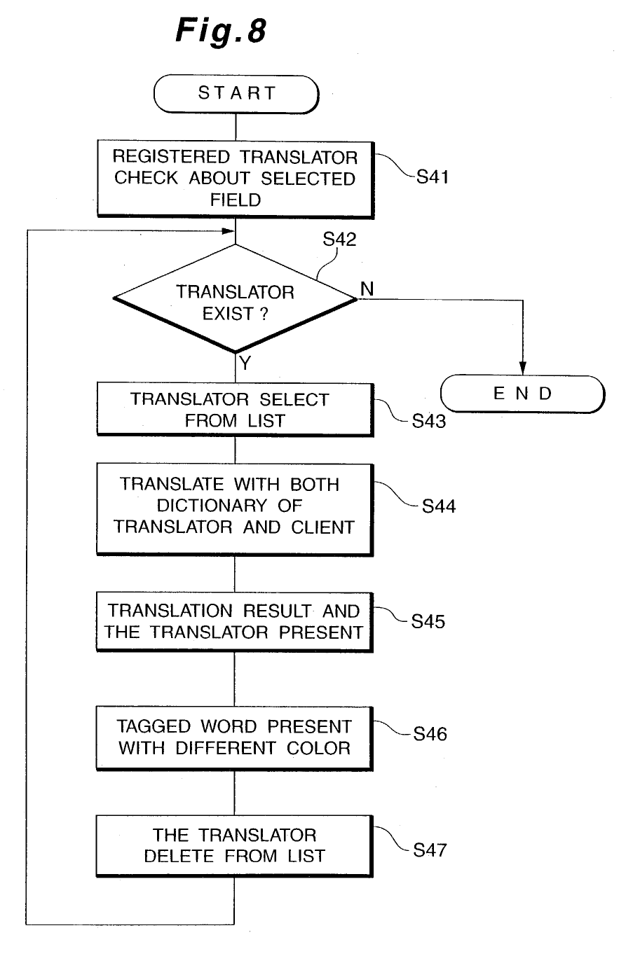

FIG. 8 is a flowchart showing the process of presenting an automatic translation result of Second Embodiment. And, the process is described according to the steps designated with “S” in this FIG. 8.

S41: The user managing means 5 searches user information database 7 for the translators of field selected by the client requesting for translation. And, it makes a checklist of corresponding translators.

S42: The user managing means 5 judges whether there is any translator existed in the checklist. And, if any translator does not exist, the process ends.

S43: The user managing means 5 selects a translator in the checklist. And, it informs the automatic translating means 10 of the translator's identification code.

S44: The automatic translating means 10 reads out the dictionary registered in the translator dictionary database 11 according to the translator's identification code. Moreover, it reads out the dictionary registered in the client dictionary database 15 according to the client's identification code given in advance. And, with these two dictionaries as well as ordinary system dictionary, an automatic translation is performed.

In this circumstance, there can be an occasion when the same word is registered in more than two dictionaries of these three dictionaries. In this occasion, the dictionary which client requesting for translation made has the highest priority in using.

As for this embodiment, the priorities have a relation as follows. dictionary made by client requesting for translation >dictionary made by translator>system dictionary

S45: The result presenting means 9 presents the user name of translator who used the dictionary, translation result etc. at the display of the client's terminal, for example, client terminal 1A.

S46: The result presenting means 9 presents the color of translated word attached with a tag of <user>in translation result (translated document), discriminating from other translated words.

S47: The user managing means 5 deletes the translator who used the dictionary from the checklist. And, the process returns to S42.

As described above in Second Embodiment, the clients requesting for translation are able to appoint translated words (for example, to appoint how to translate their product name etc.). Therefore, as well as the effects of First Embodiment, there is an effect that even highly sophisticated translation result can be obtained.

Moreover, the client requesting for translation can register dictionary to appoint translated words. And, the dictionary is used by translators when translation is requested. Therefore, the client requesting for translation does not have to appoint words at every request. As a result, the client can easily obtain translated document with preferable words. On the other hand, the translators do not have to refer to list of translated word for translation. Because, all the appointed words in the document are automatically translated by translation mediate server according to the client's dictionary where translated words are ready as the client requesting for translation appointed.

In addition, in this Second Embodiment, tags are attached when the client requesting for translation registers dictionary. But, these are used only for discriminating the translated words appointed in client's dictionary, when translation result is put out. So, it is not necessary to attach tags as far as the translated words can be made discriminated.

Moreover, the translated words appointed by client requesting for translations are presented with certain color different from that of other words. But, these can be made discriminated from other translated words by presenting with, for example, bold letters or some other expression like that.

<Third Embodiment>

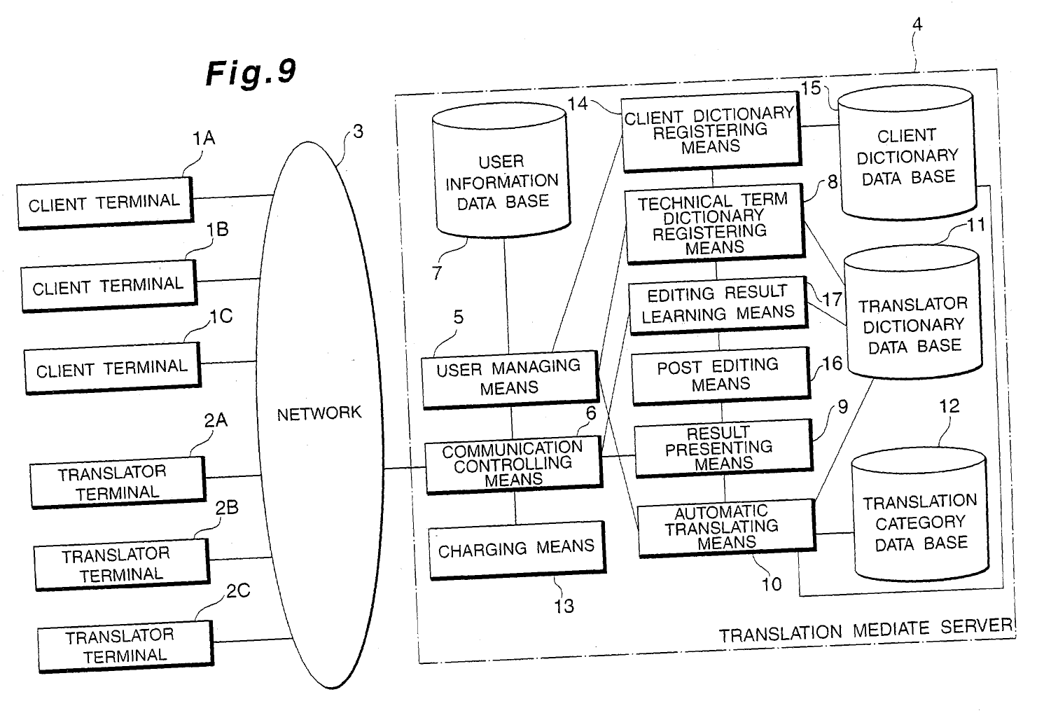

FIG. 9 is a block diagram showing a configuration of Third Embodiment.

The configuration of Third Embodiment is made by adding an post editing means 16, and an editing result learning means 17 to the configuration of Second Embodiment. These are equipped to the translation mediate server 4.

Here, the post editing means 16 is what is used by the translator to correct the result of automatic translation. And, it has a function of presenting a screen for correcting translation result at the display of translator terminal 2A to 2C.

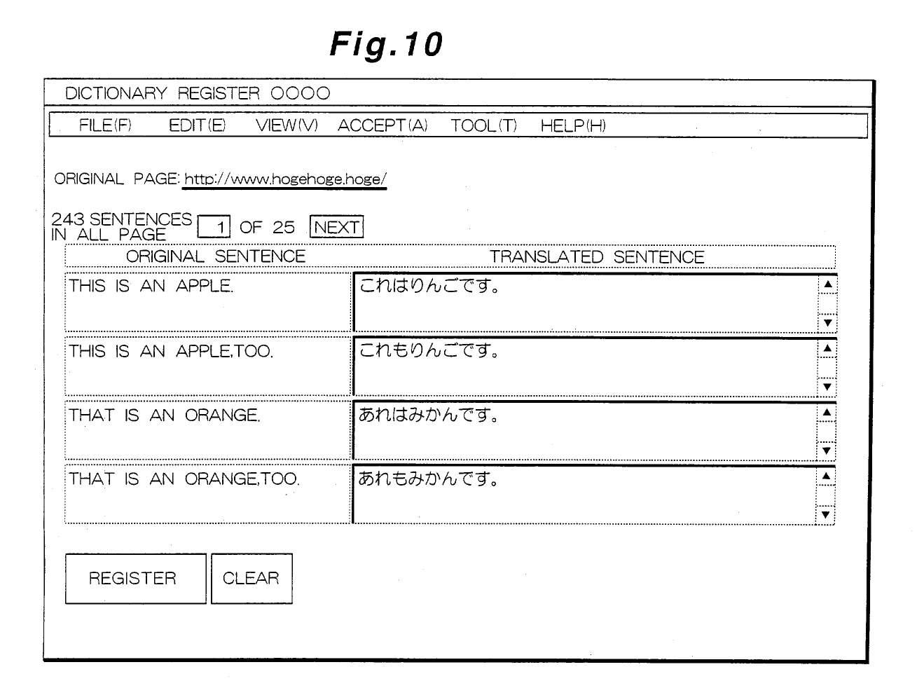

FIG. 10 shows an example of screen for correcting translation result (an example of post editing screen). In this FIG. 10, translation results of parts of document are presented in bilingual format.

If there is any wrong translated sentence, it is corrected to proper sentence with keyboard etc. And, the correcting is registered by pressing a registering button with mouse etc. Then, the corrected sentence is given to the editing result learning means 17 as an after correcting result.

The editing result learning means 17 is what makes dictionary automatically from the result of post editing, to use it for translation at other requests.

This automatic making of dictionary by editing result learning means 17 can be realized with conventional technique known well.

In addition, the other elements of configuration are designated with the same symbols as those in Second Embodiment (FIG. 6) to omit description.

In this Third Embodiment, the process of selecting translator at translation request, the process of registering dictionary by translator, the process of registering dictionary by client requesting for translation, and the process of presenting translation result are same as First or Second Embodiment. So, the description is omitted.

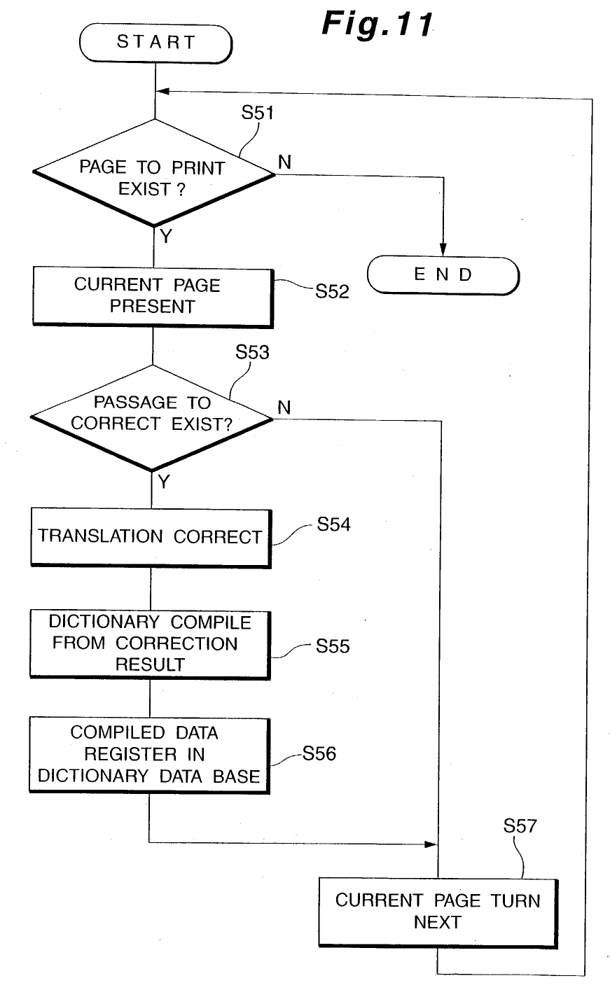

FIG. 11 is a flowchart showing the process of correcting translation result. Here, shown is an occasion when the translator translates whole of document, which the client requesting for translation requested to translate, by the automatic translating means of translation mediate server 4. And, in this occasion, the translated document is corrected.

As for this translation, dictionaries of the translator, the client requesting for translation, and system have been used. Hereafter, the process is described according to the steps designated with “S” shown in FIG. 11.

S51: The post editing means 16 checks whether there is any page to present in the translated document or not. If there is not any page to present, the process ends.

S52: The post editing means 16 presents the original document and translated document of present page, at the display of corresponding translator terminal, for example, translator terminal 2A.

In this presentation, the words of client's dictionary (translated word) are presented as discriminated from other words, not to make wrong correction.

S53: The translator checks each part of document judging whether it needs to be corrected or not. And, check result is inputted.

For example, in an example of FIG. 10, if a part does not need to be corrected, the translator clicks the area designated with “NEXT”. In that occasion, the process proceeds to S57.

S54: If a part needs to be corrected, the translator corrects the translation result on the screen of FIG. 10. And, after correcting, the translator clicks the button of “register”.

S55: The editing result learning means 17 automatically makes a technical term dictionary according to the result translator corrected.

S56: The dictionary made above is registered in translator dictionary database 11 by translation result learning means 17. That is, a new dictionary data is added to the dictionary of translator who made correction.

S57: The post editing means 16 turns the new page to present. And, the process returns to S51. Thereafter, same steps are repeated until page to present ends.

According to Third Embodiment described above, as well as the same effects as those of Second Embodiment, another effect is obtained as follows.

As described above, the translator uses automatic translation for document requested to translate. And, after automatically translated, the result of translation is corrected by the translator via translation mediate server. Besides, according to the corrected result, revised dictionary is automatically made to register. Therefore, translation results with high quality come to be obtained in high probability at other opportunities of translating similar documents.

<Fourth Embodiment>

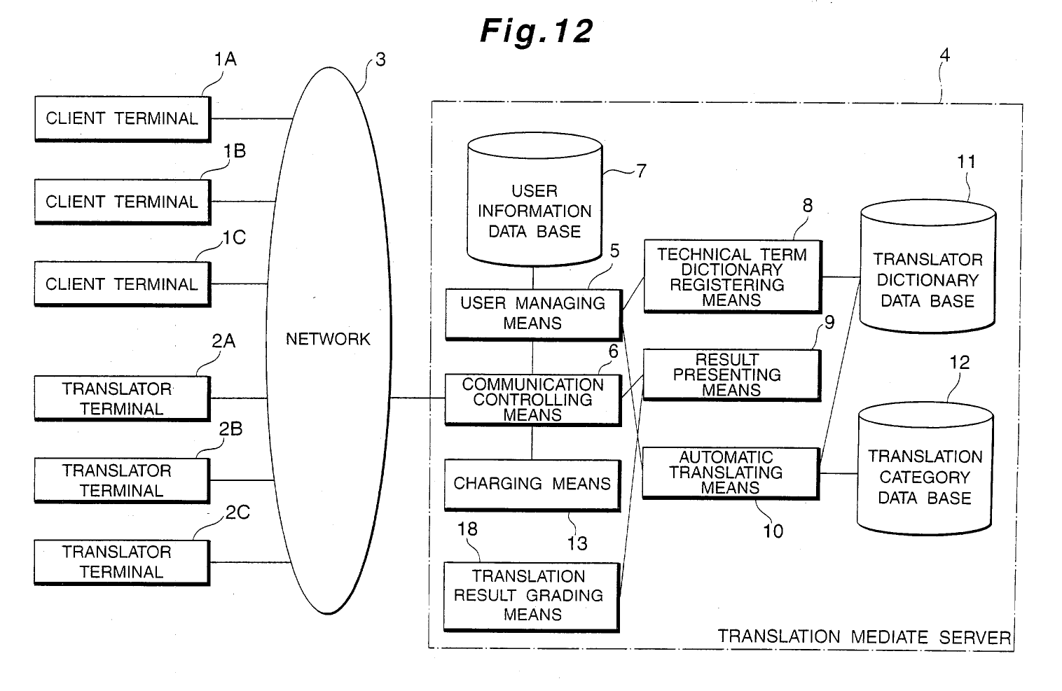

FIG. 12 is a block diagram showing a configuration of Fourth Embodiment.

The configuration of this embodiment is what is added to the configuration of First Embodiment, a translation result grading means 18. This translation result grading means 18 is what grades the result of automatic translation by automatic translating means 9 to let the client know what is the score of it. This means is equipped to translation mediate server 4.

In addition, other elements of configuration are designated with the same symbols as those of First Embodiment (FIG. 1) to omit the same description.

Moreover, in this Fourth Embodiment, the process of registering dictionary by translator is same as the process of First Embodiment described in FIG. 3. So, the same description is omitted.

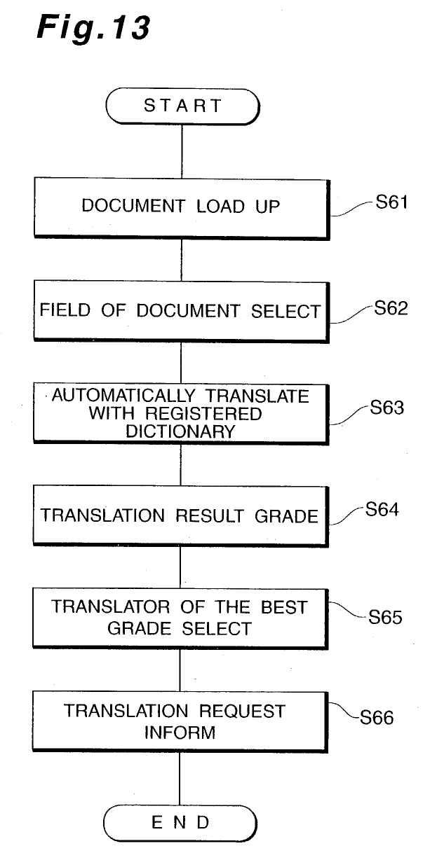

FIG. 13 is a flowchart showing the process of automatic selecting of translator in this Fourth Embodiment. And, this process is described according the steps designated with “S” shown in FIG. 13.

S61: At first, the client requesting for translation operates, for example, client terminal 1A to connect to translation mediate server 4. And, the initial screen is provided from translation mediate server 4. On this screen, the client selects translation request. And, the client loads up document to be translated from this client terminal 1A to translation mediate server 4.

Here, a part of document will do. That is, whole document does not need to be loaded up at this moment. Because, this is a trial translation with automatic translation.

The document loaded up is memorized in memory not shown in the drawings equipped to translation mediate server 4.

S62: The client requesting for translation selects the field of document to be translated, on the screen presented at the display of client terminal 1.

S63: As the field is selected, user managing means 5 searches user information database 7 for translator corresponding to the selected field. And, according to the searching result, automatic translating means 10 reads corresponding dictionary out of translator dictionary database 11 And, by using that dictionary and another dictionary installed in system, translation of the document is performed.

The translation of this occasion is performed similarly as First Embodiment. And, as for all the translators, by using each dictionary, each translation is performed.

S64: The translation result grading means 18 performs grading automatic translation result of automatic translating means 10.

As for the grading method, various methods can be adopted, for example, calculating numbers of unknown words which are unregistered in dictionaries, and left untranslated in Japanese-English translation and technical terms which are correctly translated. In this occasion, point of “−1” is given for each left word or phrase. On the other hand, point of “+1” is given for each technical term. Thus, a score is obtained.

Moreover, to this score, the number of translation requests ever accepted by the translator can be added, as a member of parameter representing the translator's experience.

S65: The translation result grading means 18 selects the most appropriate translator.

For example, as a result of point calculation in S64, it selects the translator who earned the best score.

And, the result presenting means 9 presents the client requesting for translation with the translator that the translation result grading means 18 selected as well as the translation result, on the screen at display of client terminal 1A.

S66: Here, the client requesting for translation can approves of the choice of translator that the translation result grading means 18 made, or disapproves of it. This operation can be performed with the client terminal 1A. If the client approved of it, the translation mediate server 4 informs the selected translator of translation request.

For example, when the selected translator exists at the translator terminal 2A, it informs the translator terminal 2A of the translation request.

In addition, in the process mentioned above, the automatic translation is performed with translator's dictionary and system dictionary. But, the client's dictionary can be used as well as these. And, in that occasion, the grading by translation result grading means 18 can also be performed.

According to Fourth Embodiment described above, grading of the result of translation is automatically performed by translation mediate server. Therefore, the client requesting for translation can easily select translator without contrasting translation results with each other one by one. So, this embodiment is useful when the client requesting for translation is not accustomed to, for example, English well or such occasions like that. Because, for example, when Japanese document is translated into English, English document translated with high translation quality is automatically selected by system in a certain probability.

In addition, in Fourth Embodiment, only the best one translation result and the best one translator are presented to client terminal. But, the best ten or something like that of both translation result and translator can be presented to the client, presenting with offering date or charge amount etc. These enable the client requesting for translation to select a translator from adequate number of them.

<Fifth Embodiment>

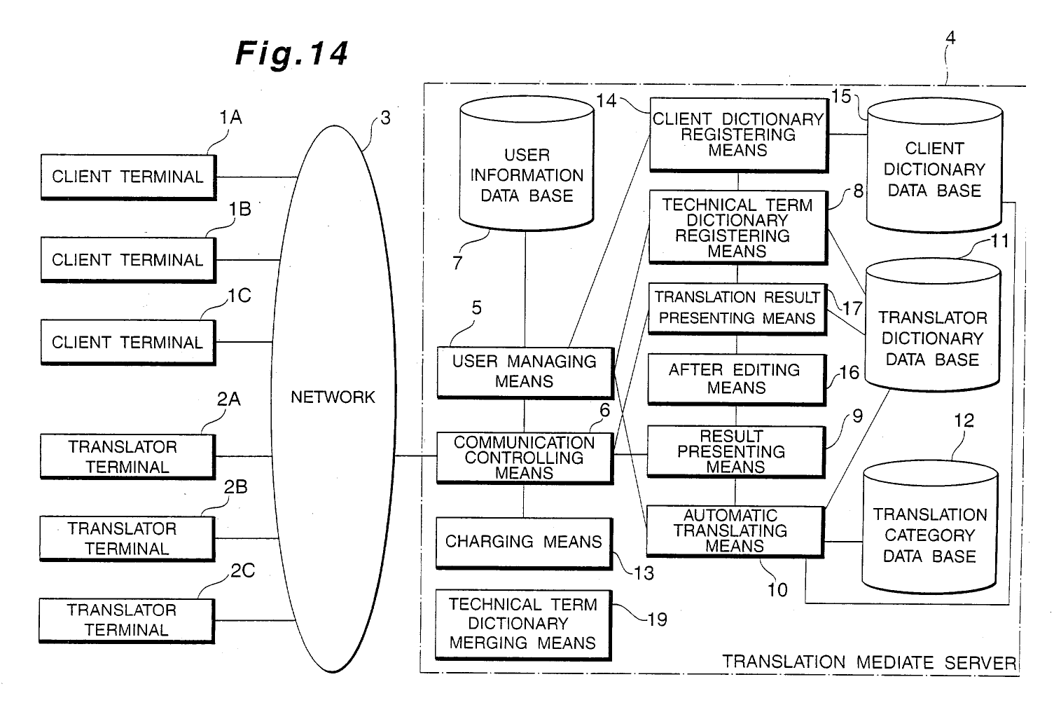

FIG. 14 is a block diagram showing a configuration of Fifth Embodiment.

The configuration of this embodiment is comprised as adding a technical term dictionary merging means 19 to the configuration of Third Embodiment.

This technical term dictionary merging means 19 is what merges dictionary data of others in the same field with the translator's dictionary according to the translator's indication. This is equipped to translation mediate server 4.

In addition, the other elements of configuration are designated with the same symbols as those of Third Embodiment (FIG. 9) to omit the same description.

In this Fifth Embodiment, the process of selecting translator, the process of registering dictionary by translator or client requesting for translation, and the process of selecting translator by client requesting for translation are same as those of Third Embodiment. So, the same description is omitted.

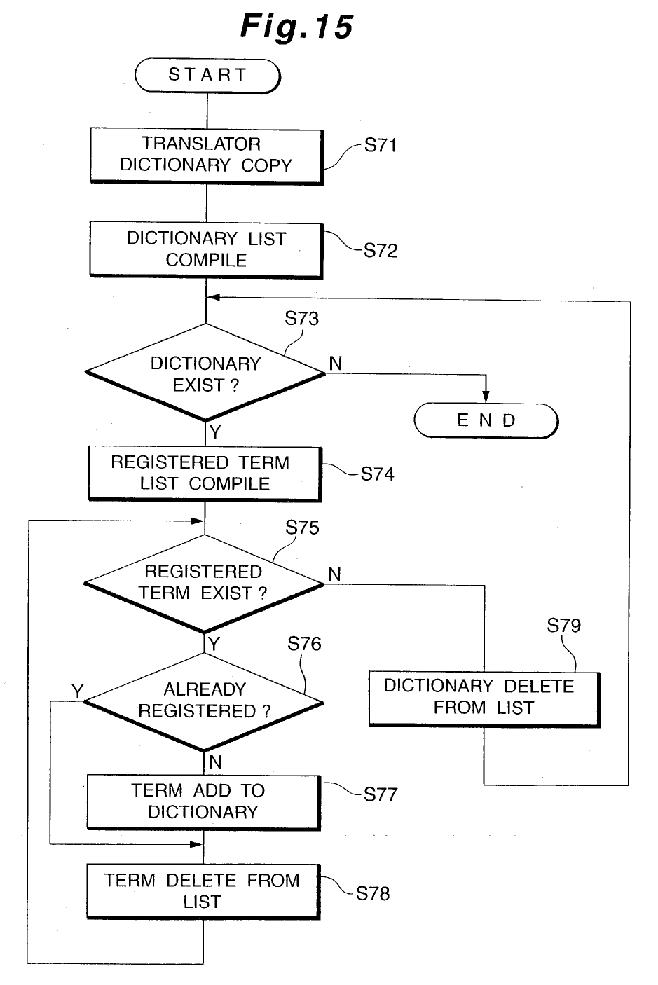

FIG. 15 is a flowchart showing the process of merging translators' dictionary. Here, it shows the occasion when the translator let the automatic translation means of translation mediate server 4, translate whole of the document requested from client requesting for translation. In this occasion, other translators' dictionaries in the same field are merged with the translator's dictionary.

Hereafter, the merging process is described according to the steps designated with “S” shown in FIG. 11.

S71: At first, a new dictionary is made from copy of the translator's dictionary data. With this data document requested for translation is automatically translated. That is, according to the indication of user managing means 5, the technical term dictionary merging means 19 reads translator's dictionary out of the translator dictionary database 11. With this translator's dictionary automatic translation of the requested document is going to be done. And, it is memorized in memory not shown in the drawings as a new dictionary.

S72: The technical term dictionary merging means 19 makes a list of technical term dictionaries registered in the same field as the field of translator's dictionary.

For example, if five translators are registered in the same field, four dictionaries are listed as being aside from the translator's own one.

As to make this list, the user managing means 5 searches user information database 7 for other translators in the same field. And, the technical term dictionary merging means 19 reads other translator's dictionaries out of translator dictionary database 11 according to the searching result. Thus, a dictionary list is made.

S73: The technical term dictionary merging means 19 checks the list whether any dictionary is in it. If any is not, the process ends.

S74: If any dictionary is in the list, the technical term dictionary merging means 19 selects one dictionary. And, it makes a list of terms registered in the selected dictionary.

S75: The technical term dictionary merging means 19 checks the term list whether any term is in it. If any is not, the process proceeds to S79.

S76: If some term is in the list, the technical term dictionary merging means 19 selects one term in the term list. And, it checks the new dictionary previously made whether the selected term already registered in it or not. If it is registered in it, the process proceeds to S78.

S77: The technical term dictionary merging means 19 registers the selected term in the dictionary newly made.

S78: The technical term dictionary merging means 19 deletes the term from the term list as it is registered in the newly made dictionary. And, the process returns to S75, so as to repeat the same steps S75 to S78 until term ends.

S79: The technical term dictionary merging means 19 deletes the present selected dictionary from the dictionary list. And, the process returns to S73, so as to repeat the same steps S73 to S79 until dictionary in the dictionary list ends.

In the process described above, a new technical term dictionary is made. And, by using this newly made technical term dictionary the automatic translating means 10 becomes to perform progressive translation.

Although this new dictionary is basically a dictionary the translator made, translation with still higher quality can be performed, because this new dictionary contains not only terms the translator himself or herself registered but also terms the other translators registered.

In this occasion, it is considered that charges for translation are also paid to other translators who have not received the request for translation and whose dictionaries are referred for translating terms. That is, the charging means 13 calculates the number of each of those terms. And, it pays charges to the translators who registered that dictionary.

According to Fifth Embodiment described above, as well as the effects of Third Embodiment, translation with progressively high quality is performed. Moreover, each time other translator's term is used charge for the use is paid to the other translator. Therefore, there is still another effect that the system becomes to be very beneficial to the other translator.

What is claimed is:

1. A translation mediate system wherein:
at least one translation dictionary made by translator is registered in translation mediate server being classified into corresponding special fields,
document to be translated is sent from client terminal of client requesting for translation to the translation mediate server,
this document is automatically translated by using registered translation dictionary corresponding to this document field,
the translation result is sent to the client terminal for the client requesting for translation to select the best translator, and
the selected translator at the terminal is informed of translation request from the translation mediate server.

2. A translation mediate system according to claim 1 wherein only the client requesting for translation registered in the translation mediate server is enabled to perform automatic translation of document for selecting translator.

3. A translation mediate system according to claim 1 wherein the translation mediate server uses all the translators' dictionaries corresponding to the field of document, to perform translation.

4. A translation mediate system according to claim 1 wherein the client's own dictionary is registered in the translation mediate server, and the translation mediate server uses all the translator's dictionaries and the client's own dictionary, corresponding to the field of document to be translated, to perform translation.

5. A translation mediate system according to claim 3 wherein the translation mediate server grades translation result for each translator, selects the best at least one translation result, and sends the selected translation result to the client terminal.

6. A translation mediate system according to claim 1 wherein the translation mediate server sends whole automatically translated document to the translator terminal, for the translator to correct the automatically translated document.

7. A translation mediate system according to claim 6 wherein the translation mediate server uses terms in the client's dictionary prior to the translator's dictionary when the translator's dictionary and the client's dictionary are used in automatic translation.

8. A translation mediate system according to claim 6 wherein the translation mediate server presents the translator terminal with terms in the client's dictionary discriminating from other terms in the document which is translated by using the translator's dictionary and the client's dictionary.

9. A translation mediate system according to claim 6 wherein the translation mediate server automatically makes a new dictionary according to the corrected result, and registers the new dictionary as the translator's dictionary.

10. A translation mediate system according to claim 6 wherein the translation mediate server merges terms of other translator's dictionary into the translation request received translator's dictionary to make a new dictionary, and automatically translates the client's document by using this new dictionary.

11. A translation mediate system according to claim 10 wherein the other translator receives charge as well as the translation request received translator when terms in the other translator's dictionary are used for translating document.

12. A translation mediate server comprising:
a database for registering the translation dictionary which the translator made, in divided special field;
an automatic translating means for automatically translating document sent from client terminal, by using translation dictionary corresponding to the document field;
a result presenting means for presenting the translation result at the client terminal.

13. A translation mediate server according to claim 12 further comprising another database for registering translation dictionary which the client requesting for translation made, in divided special field.

14. A translation mediate server according to claim 12 further comprising a translation result grading means for grading translation result obtained by the automatic translating means with each translator's dictionary, to select at least one translation result with high quality.

15. A translation mediate server according to claim 12 further comprising an after editing means for sending translator terminal whole document automatically translated, to be corrected the translation result.

16. A translation mediate server according to claim 15 further comprising an editing result learning means for automatically making a new dictionary according to the correcting result, and registering the new dictionary as the translator's dictionary.

17. A translation mediate server according to claim 12 further comprising a dictionary merging means for merging terms of other translator's dictionary into translation request received translator's dictionary, to make a new dictionary.

18. A translation mediate method comprising:
a process of registering at least one translation dictionary made by translator at translation mediate server being classified into corresponding special fields,
a process of sending the translation dictionary data to the client terminal for the client requesting for translation to select the best translator, and
a process of informing the selected translator at the terminal, of translation request from the translation mediate server.

19. A translation mediate method according to claim 18 further comprising:
after the process of registering translation dictionary at translation mediate server,
a process of sending document to be translated, from client terminal of client requesting for translation to the translation mediate server,
a process of translating automatically this document by using registered translation dictionary corresponding to this document field, and
a process of sending the translation result to the client terminal for the client requesting for translation to select the best translator.

20. A translation mediate method according to claim 18 further comprising:
after the process of registering translation dictionary at translation mediate server, and the process of sending the translation dictionary data to the client terminal
a process of translating document automatically at the client terminal by using sent translation dictionary data, so as to obtain translation result for the client requesting for translation to select the best translator and inform the selected translator of translation request via the translation mediate server.
